(19) United States
(12) Patent Application Publication
(10) Pub. No.: US 2017/0093887 A1
(43) Pub. Date: Mar. 30, 2017

(54) NETWORK COMMAND EVALUATION AND RESPONSE SYSTEM

(71) Applicant: General Electric Company, Schenectady, NY (US)

(72) Inventors: Matthew Richard Schwartz, Mechanicville, NY (US); Donald Carter, Glen Allen, VA (US)

(21) Appl. No.: 14/863,825

(22) Filed: Sep. 24, 2015

(51) Int. Cl. H04L 29/06; H04L 29/08

(52) U.S. Cl. CPC H04L 63/1416; H04L 67/125; H04L 63/1425; H04L 63/102

(57) ABSTRACT

A system includes a first computing device to (a) determine a first command conforming to an industrial control protocol and transmitted to a second computing device on a first computing network; (b) determine whether a second command corresponding to the first command was detected by a third computing device of a second computing network; (c) determine whether the first command was transmitted from one of one or more predetermined Internet Protocol subnets; (d) determine whether the command was issued by an expected issuing device; (e) determine whether the command was issued by an expected issuing software application; and determine a validity score based on determinations (b) through (e) and associate the validity score with the command.

### BACKGROUND

Industrial control systems (ICSs) monitor and control the operation of industrial devices, such as pumps, compressors, motors, generators, wind turbines, gas turbines, and other devices. To protect such devices from cyber attacks, it is desirable to physically separate an industrial network from other computer networks. In particular, it is desirable to physically separate an industrial network from any computer network which may be in communication with a public network.

However, it is not always feasible to completely isolate an industrial network. For example, an enterprise network may provide a Human-Machine Interface (HMI) device for communicating with the controllers of an ICS, and may provide data used to execute the processes of the ICS. Because the enterprise network may also be in communication with public networks such as the Internet, it is necessary to provide control mechanisms to efficiently protect the ICS from unauthorized network traffic.

### BRIEF DESCRIPTION OF THE DRAWINGS

FIG. 1 is a block diagram of a system architecture according to some embodiments.

FIGS. 2A and 2B comprise a flow diagram according to some embodiments.

FIG. 3 is a block diagram of a computing apparatus according to some embodiments.

### DESCRIPTION

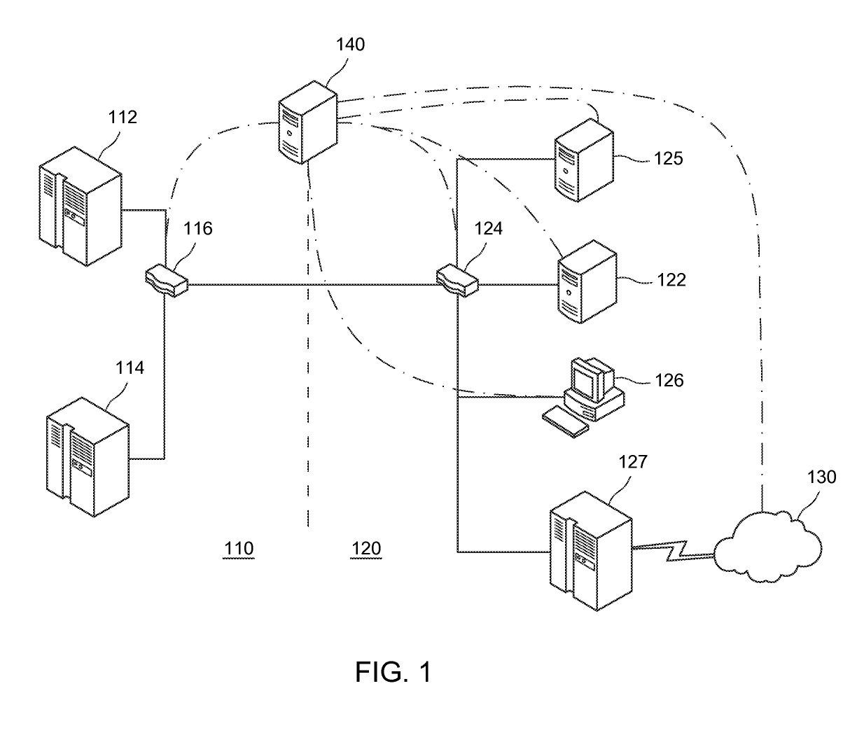

FIG. 1 illustrates an architecture of system 100 for purposes of describing some embodiments. System 100 includes industrial network 110 and enterprise network 120. Each of networks 110 and 120 may comprise any number and type of connected devices, sub-networks and topologies, communicating over any suitable communications media via any suitable protocols. Systems according to some embodiments may include two or more industrial networks and/or enterprise networks.

Industrial network 110 may comprise an industrial control system or any other computing network for which network security is desired. Industrial network 110 includes controllers 112 and 114. Each of controllers 112 and 114 may comprise computing devices including processors to execute program code to monitor, control and/or otherwise manage industrial devices (not shown) as described above. Each of these devices may be connected to network 110 to receive network traffic (e.g., network packets) and/or directly connected to a respective controller 112 or 114. Industrial network 110 may include more than the two controllers 112 and 114 illustrated in FIG. 1.

Sensor 116 of network 110 may comprise any computing device suitable to receive network traffic passing through network 110. Sensor 116 may implement rules to restrict incoming network traffic to known subnets of networks 110 and 120 (i.e., layer 3 filtering), and to traffic conforming to the industrial communications protocols which are intended for use within system 100 (i.e., layer 7 filtering). Sensor 116 may comprise a switch, a firewall, and/or a router according to some embodiments, and may be implemented by a software/virtual appliance or an embedded appliance created and executed by a hypervisor. According to some embodiments, sensor 116 may support automated configuration via secure out-of-band protocols (e.g., a RESTful API).

Enterprise network 120 may include HMI device 122 for receiving commands from an administrator to remotely administer all or a portion of network 110. Such administration may occur via a Web-based user interface.

Sensor 124 of network 120 may comprise any computing device suitable to receive network traffic passing through network 120. Sensor 124 may perform the functions and be implemented as described above with respect to sensor 116. A system according to some embodiments may comprise additional networked sensors.

Enterprise network 120 also includes Active Directory server 125, workstation 126 and historian 127. In the examples provided below, Active Directory server 125 provides user login data, workstation 126 provides environmental data and historian 127 stores historical environmental and validity data. Historian 127 is in communication with internet 130 in some embodiments in order to provide additional data for the analysis described below. Validity data will be described in detail below. According to some embodiments, one or more of the functions attributed to a device of network 120 may be performed by a single device or multiple devices.

Analysis engine 140 comprises one or more computing devices including one or more processors to execute program code to perform functions as described herein. In order to perform such functions, and as illustrated in FIG. 1, analysis engine 140 receives data from sensors 116 and 124, from Active Directory server 125, from workstation 126 and from historian 127.

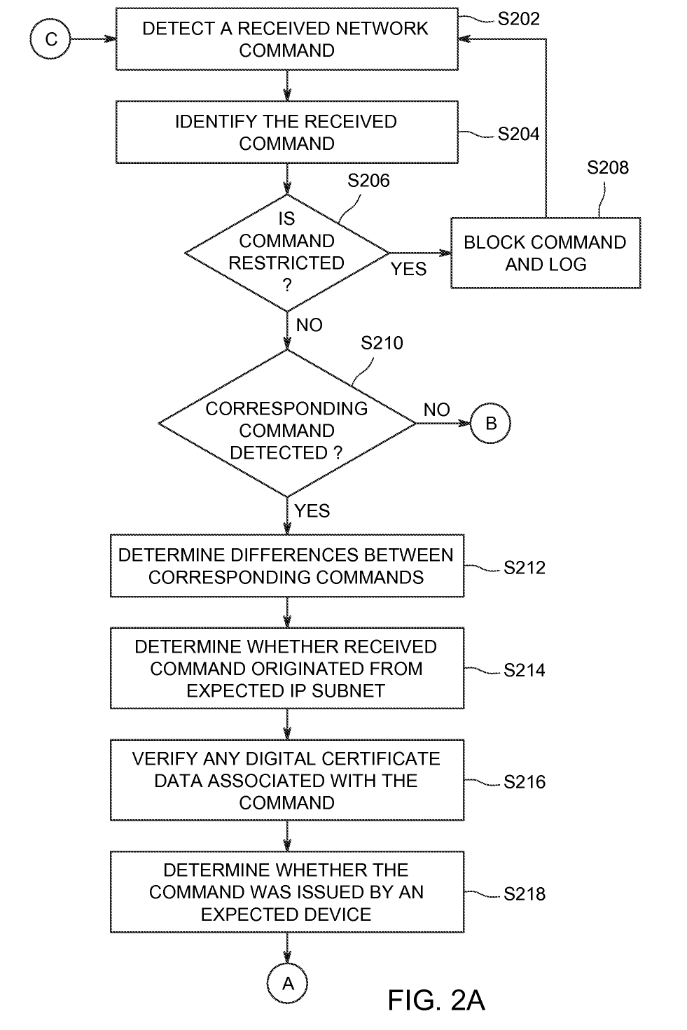

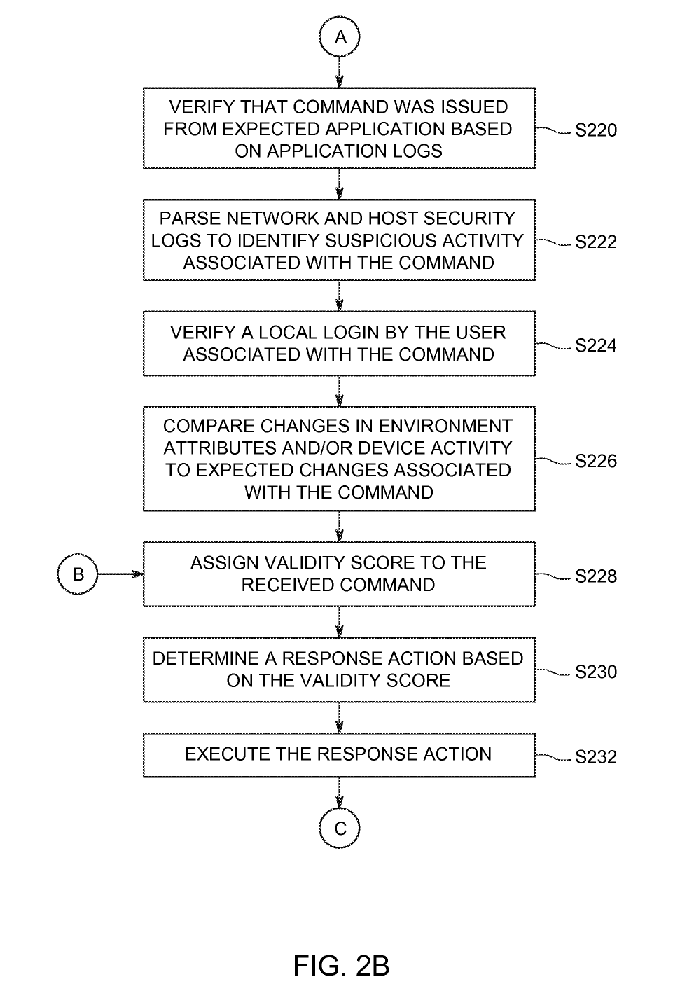

FIGS. 2A and 2B comprise a flow diagram of process 200 executed by analysis engine 140 according to some embodiments. In some embodiments, one or more various hardware processing units (e.g., processor(s), processor core(s), execution thread(s)) of analysis engine 140 execute program code to perform process 200. Process 200 and other processes mentioned herein may be embodied in processor-executable program code read from one or more non-transitory computer-readable media, such as a floppy disk, a CD-ROM, a DVD-ROM, a Flash drive, and a magnetic tape, and then stored in a compressed, uncompiled and/or encrypted format. In some embodiments, hard-wired circuitry may be used in place of, or in combination with, program code for implementation of processes according to some embodiments. Embodiments are therefore not limited to any specific combination of hardware and software.

Prior to S202, network sensors are instantiated and configured with a base policy. With reference to the example of system 100, analysis engine 140 may operate to instantiate sensors 116 and 124 and configure them with firewall rules to restrict traffic to the known IP address subnets of networks 110 and 120, and with protocol monitoring rules to restrict traffic to the industrial protocols in use. Log feeds generated by HMI device 122, Active Directory 125 and historian 127 may also be configured to feed analysis engine 140.

At S202, a command is received by sensor 116 and thereby detected by analysis engine 140. The command is identified at S204 in terms of its protocol, command type and payload. Examples thereof include a Modbus Transmission Control Protocol command to write multiple holding registers with a block of data, a HyperText Transmission Protocol POST command with a base 64 encoded object, and a Distributed Network Protocol (DNP3) Integrity Poll command with no payload, but embodiments are not limited thereto.

Analysis engine 140 determines whether the command is restricted at S206. The determination at S206 may be based, for example, on a whitelist which lists allowed protocols, command types and payloads. If the identified protocol, command type and payload of the received command is not listed on the whitelist, it may be determined at S206 that the command is restricted. If so, flow proceeds to S208, at which the command is blocked (i.e., not allowed to pass sensor 116) and the blocking is logged. According to some embodiments, Flow then returns to S202 to await detection of a next received command.

Flow proceeds to S210 if it is determined at S206 that the command is not restricted. At S210, it is determined whether any corresponding command was detected by another network sensor. For example, if the command was received by sensor 116, S210 includes determining whether sensor 124 detected a corresponding command on network 120 (i.e., was the command sent from network 120 to network 110). Analysis engine 140 may attempt to detect the corresponding command based on a log feed received from sensor 124. If no such corresponding command is detected, flow proceeds to S228 to compute a validity score for the received command. Computation of a validity score according to some embodiments will be described below.

Assuming that a corresponding command is detected at S210, differences between the corresponding commands are determined at S212. S212 may comprise comparing the protocol, command type and payload of the corresponding commands. If any of these or other attributes are not identical, the differences are recorded at S212.

Next, at S214, it is determined whether the received command originated from an expected IP subnet. For example, analysis engine 140 may store IP subnet values associated with network 120 (or any other network authorized to communicate with network 110) and determine whether the originating IP address of the command is within an authorized subnet. According to some embodiments, S214 comprises determining whether the originating IP address of the command is one of several specifically-authorized IP addresses stored by analysis engine 140.

In a case that system 100 supports digital certificates, S216 comprises verification that the certificate authority and other parameters of the Secure Socket Layer/Transport Layer Security metadata are valid. Then, at S218, it is determined whether the command was issued by an expected device. The determination at S218 may include checking whether the originating IP address and MAC address of the command is identical to an IP address and MAC address of an authorized HMI device. Analysis engine may store these addresses in order to perform the determination of S218. Other command attributes may be checked at S218 to determine whether they conform to the attributes of commands originating from an authorized device, such as, but not limited to, Time To Live, and window frame size. Additionally, analytics may be used at S218 based on transitional and numeric data, such as flow data, Authentication, Authorization and Accounting services, directory services, and certificate chain evaluation.

Next, at S220, analysis engine 140 may verify whether the command was issued from an expected application. As illustrated in FIG. 1 and mentioned above, analysis engine 140 may receive application logs from HMI device 122, and these logs may be used at S220 to determine whether the received command was issued by an authorized application of HMI device 122.

Network and security logs are parsed at S222 to identify suspicious activity associated with the command. These logs may be received from HMI device 122 and may consist of Intrusion Prevention System and/or Intrusion Detection System logs which flag suspicious activity.

At S224, a local login by a user associated with the command is verified. The verification of S224 assumes that, if the command was issued by a user of an authorized device, then the user must have been properly logged into the device at the time the command was issued. In one example, login information is recorded and provided to analysis engine 140 by active directory 125 for use in S224. S224 may also include analysis of passkey or building security data to determine whether the user was properly located in the building or room with the authorized device executing the authorized application at the time the command was issued.

S226 comprises a determination of whether environmental attributes have changed as expected in response to the command. Analysis engine 140 may consult logs from historian 127 to determine historical environmental data (e.g., plant air temperature, external air temperature, etc.) and receive current environmental data from workstation 126 in order to determine whether current conditions match expected conditions in view of the command.

For example, if the command comprises a command to increase the rotation speed of a turbine, S226 may include determining whether the air temperature near the turbine has increased an expected amount. This determination may take into account external air temperatures. For example, if the external air temperature has dropped significantly, then the expected increase in air temperature near the turbine may be less than would otherwise be expected.

In another example, the command is a command to increase the rate at which fuel is burned. S226 may therefore comprise a determination of whether steam output has increased as a result. If the command is a command to open a relay, S226 may comprise a determination of whether the relay is indeed open.

Analysis engine 140 may store data indicating expected environmental changes in response to particular commands. This data may be used to execute the comparison of S226.

At S228, a validity score is assigned to the received command based on the execution of S212 through S226. The validity score may be based on the degree to which any of the determinations/verifications of S212 through S226 indicate that the command is valid. Each determination/verification may be associated with a different weighting in determining the validity score. For example, a determination at S218 that the command did not originate from an expected subnet may carry less weight than a determination that the command was not issued from an expected application at S220.

According to some embodiments, and based on the prior history of received commands and validity scores, or the configured security posture/sensitivity of the system, the verifications in steps S212-226 could trigger an immediate escalation to S228.

A response action is determined at S230 based on the validity score. Any network security response action that is or becomes known may be determined at S230, including but not limited to one or more of: logging the validity score locally at analysis engine 140; logging the validity score remotely at historian 127; transmitting an e-mail alert to a person or a group; transmitting an Short Messaging Service alert to a person or a group; modifying network sensors to present a lower-posture monitoring configuration; modifying network sensors to present a higher-posture monitoring configuration; modifying network sensors to allow certain traffic; and modifying network sensors to block certain traffic.

According to some embodiments, algorithms such as machine learning and alert consolidation are executed at S230 to raise the level of an alert based upon aggregated prior validity scores, which are stored in historian 127. Some embodiments are configurable to allow certain network traffic to pass without credentials based on the nature of the network traffic.

Some embodiments provide enhancements to the security posture of industrial environments. Notably, the determination of whether a command is observed from both the HMI and controller network segments provides assurance that will be effective for legacy protocols which do not incorporate authentication or authorization mechanisms.

Several specific examples of process 200 according to some embodiments will now be presented. Embodiments are not limited to these examples.

The first example describes “normal” execution in the case of a properly-issued command which does not result from any threat on the network. Initially, the command is received by sensor 116 at S202. The command is detected by analysis engine 140 and identified as a DNP3 Integrity Poll command at S204. It is then determined at S206 that the command is not restricted and flow proceeds to S210.

At S210, analysis engine 140 checks the logs of sensor 124 and determines that a corresponding command was received at sensor 124. At S212, no difference is determined between the commands received at sensor 116 and sensor 124. It is also determined at S214 that the command originated from an expected subnet (e.g., a subnet of network 120).

It will be assumed that no digital certificate is provided and therefore none is detected at S216. At S218, it is determined that the host device originating the command is the actual HMI device assigned to the receiving controller. Moreover, at S220, it is determined, based on the application logs of the HMI device, that the application running on the HMI device issued the command. Parsing of the network and host security logs at S222 results in a determination that no suspicious activity is associated with the command.

The logs of Active Directory 125 are reviewed at S224 and show an authenticated login to the HMI device by an authorized user. At S226, it is confirmed that the controller responds with Integrity Poll data as expected, and no other change in controller settings is detected. A high validity score is assigned to the command at S228, indicating a high confidence that the command is benign. A corresponding response action to log the command is determined at S230, and the command is logged for future reference at S232.

The next example illustrates a case in which a received command results from a threat on the network. As before, the command is received by sensor 116 at S202. The command is detected by analysis engine 140 and identified as a TCP Modbus Write Multiple Holding Registers command at S204. At S206, it is then determined that the command is not restricted and flow proceeds to S210.

At S210, analysis engine 140 checks the logs of sensor 124 and determines that a corresponding command was received at sensor 124. Again, no difference is determined at S212 between the commands received at sensor 116 and sensor 124. It is also determined at S214 that the command originated from an expected subnet (e.g., a subnet of network 120).

No digital certificate is provided and none is detected at S216. At S218, it is determined that the host device originating the command is not recognized. Accordingly, at S220, it is determined, based on the application logs of the HMI device assigned to the controller, that the application running on this HMI device did not issue the command Next, at S222, the network and host security logs are parsed to determine that suspicious has been detected on perimeter Intrusion Detection System services.

The logs of Active Directory 125 are reviewed at S224 and do not show an authenticated login to the HMI device by an authorized user. At S226, it is confirmed that the controller responds with an acknowledgement of the command as expected, that the controller begins increasing the RPM of a turbine and the temperature of the turbine begins to increase. A low validity score is assigned to the command at S228, indicating a high confidence that the command is malicious. At S230, a response action to notify Response Team personnel is determined, and a notification is transmitted to the Response Team personnel via e-mail and SMS at S232.

In a further example, a received command results from a threat on the HMI device. The command is first received by sensor 116 at S202. The command is identified as an HTTP Post command at S204. At S206, it is then determined that the HTTP protocol is restricted by a Blacklist. For purposes of the foregoing example, it will be assumed that flow proceeds to S210 from S206 despite the positive determination at S206.

Analysis engine 140 checks the logs of sensor 124 at S210 and determines that a corresponding command was received at sensor 124. No difference is determined at S212 between the commands received at sensor 116 and sensor 124, and it is determined at S214 that the command originated from an expected subnet.

No digital certificate is provided and none is detected at S216. At S218, it is determined that the host device originating the command is the actual HMI device assigned to the receiving controller. However, at S220, it is determined, based on the application logs of the HMI device assigned to the controller, that the application running on this HMI device did not issue the command. Suspicious activity is detected in the HMI device Intrusion Detection System logs at S222.

At S224 it is determined that the logs of Active Directory 125 do not show an authenticated login to the HMI device by an authorized user. At S226, it is confirmed that the controller responds with an acknowledgement of the Post command as expected, and that no other changes are detected. A medium validity score is assigned to the command at S228, indicating a medium confidence that the command is malicious. Based on the validity score, a response action to shift the system's alert posture to a higher sensitivity is determined at S230. Next, at S232, the Blacklist is modified to indicate that HTTP traffic should blocked, and a notification is transmitted to the Response Team personnel via e-mail and SMS.

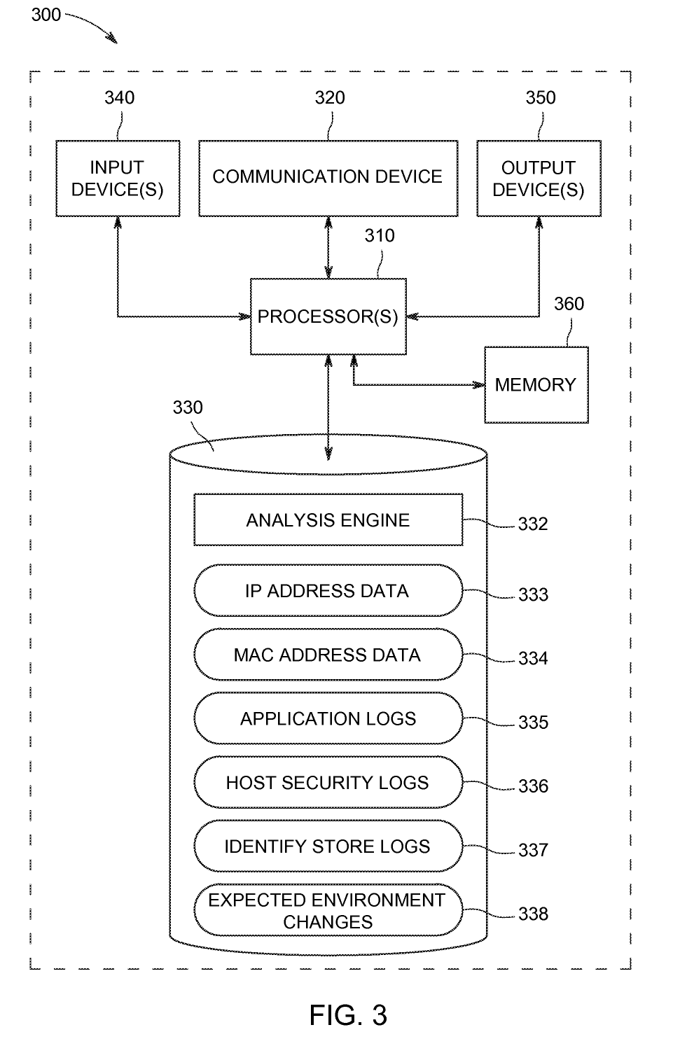

FIG. 3 is a block diagram of system 300 according to some embodiments. System 300 may include a general-purpose computing system and may execute program code to perform any of the processes described herein. System 300 may include an implementation of analysis engine 140 according to some embodiments. System 300 may include other unshown elements according to some embodiments.

System 300 includes one or more processors 310 operatively coupled to communication device 320, data storage device 330, one or more input devices 340, one or more output devices 350 and memory 360. Communication device 320 may facilitate communication with external devices, such as a reporting client, or a data storage device. Input device(s) 340 may include, for example, a keyboard, a keypad, a mouse or other pointing device, a microphone, knob or a switch, an infra-red (IR) port, a docking station, and/or a touch screen. Input device(s) 340 may be used, for example, to enter information into apparatus 300. Output device(s) 350 may include, for example, a display (e.g., a display screen) a speaker, and/or a printer.

Data storage device 330 may include any appropriate persistent storage device, including combinations of magnetic storage devices (e.g., magnetic tape, hard disk drives and flash memory), optical storage devices, Read Only Memory (ROM) devices, etc., while memory 360 may include Random Access Memory (RAM).

Analysis engine 332 may comprise program code executed by processor(s) 310 to cause computing system 300 to perform any one or more of the processes described herein. Embodiments are not limited to execution of these processes by a single apparatus.

Data storage device 330 also stores IP address data 333, MAC address data 334, application logs 335, host security logs 336, identity store logs 337 and expected environmental changes data 338, each of which may be configured and utilized as described herein. Data storage device 330 may store other data and other program code for providing additional functionality and/or which are necessary for operation of system 300, such as device drivers, operating system files, etc.

The foregoing diagrams represent logical architectures for describing processes according to some embodiments, and actual implementations may include more or different components arranged in other manners. Other topologies may be used in conjunction with other embodiments. Moreover, each system described herein may be implemented by any number of devices in communication via any number of other public and/or private networks. Two or more of such computing devices may be located remote from one another and may communicate with one another via any known manner of network(s) and/or a dedicated connection. Each device may include any number of hardware and/or software elements suitable to provide the functions described herein as well as any other functions. For example, any computing device used in an implementation of some embodiments may include a processor to execute program code such that the computing device operates as described herein.

All systems and processes discussed herein may be embodied in program code stored on one or more non-transitory computer-readable media. Such media may include, for example, a floppy disk, a CD-ROM, a DVD-ROM, a Flash drive, magnetic tape, and solid state Random Access Memory (RAM) or Read Only Memory (ROM) storage units. Embodiments are therefore not limited to any specific combination of hardware and software.

Embodiments described herein are solely for the purpose of illustration. A person of ordinary skill in the relevant art may recognize other embodiments may be practiced with modifications and alterations to that described above.

What is claimed is:

1. A system, comprising:
a first computing device to:
(a) determine a first command conforming to an industrial control protocol and transmitted to a second computing device on a first computing network;
(b) determine whether a second command corresponding to the first command was detected by a third computing device of a second computing network;
(c) determine whether the first command was transmitted from one of one or more predetermined Internet Protocol subnets;
(d) determine whether the command was issued by an expected issuing device;
(e) determine whether the command was issued by an expected issuing software application; and
determine a validity score based on determinations (b) through (e) and associate the validity score with the command.

2. A system according to claim 1, wherein the first computing device is further to:
determine a response action based on the validity score; and
control execution of the response action.

3. A system according to claim 1, further comprising:
the third computing device to transmit a network traffic log to the first computing device,
wherein the determination of whether a second command corresponding to the first command was detected by the third computing device of a second computing network is based on the network traffic log.

4. A system according to claim 3, further comprising:
a fourth computing device to transmit an application log to the first computing device,
wherein the determination of whether the command was issued by an expected issuing software application is based on the application log.

5. A system according to claim 4, wherein the first computing device is further to:
determine whether a user associated with the command was authorized to use the expected issuing device at a time the command was issued,
wherein the validity score is determined based on whether the user associated with the command was authorized to use the expected issuing device at a time the command was issued.

6. A system according to claim 1, wherein determination of whether a second command corresponding to the first command was detected by a third computing device of a second computing network comprises determination of zero or more differences between a type, a protocol and a payload of the first command and a type, a protocol and a payload of the second command, and
wherein the validity score is determined based on the determination of zero or more differences.

7. A system according to claim 1, wherein the first computing device is further to:
determine whether the command is restricted based on a type of the command; and
if it is determined that the command is restricted, blocking execution of the command.

8. A method executable by one or more computing devices in response to execution of processor-executable program code, the method comprising:
(a) determining a first command conforming to an industrial control protocol and transmitted to a first computing device of a first computing network;
(b) determining whether a second command corresponding to the first command was detected by a second computing device of a second computing network;
(c) determining whether the first command was transmitted from one of one or more predetermined Internet Protocol subnets;
(d) determining whether the command was issued by an expected issuing device;
(e) determining whether the command was issued by an expected issuing software application; and
determining a validity score based on determinations (b) through (e) and associating the validity score with the command.

9. A method according to claim 8, further comprising:
determining a response action based on the validity score; and
controlling execution of the response action.

10. A method according to claim 8, further comprising:
receiving a network traffic log from the second computing device,
wherein determining whether a second command corresponding to the first command was detected by the second computing device is based on the network traffic log.

11. A method according to claim 10, further comprising:
receiving an application log from a third computing device,
wherein determining whether the command was issued by an expected issuing software application is based on the application log.

12. A method according to claim 11, further comprising:
determining whether a user associated with the command was authorized to use the expected issuing device at a time the command was issued,
wherein the validity score is determined based on whether the user associated with the command was authorized to use the expected issuing device at a time the command was issued.

13. A method according to claim 8, wherein determining whether a second command corresponding to the first command was detected by the second computing device comprises determination of zero or more differences between a type, a protocol and a payload of the first command and a type, a protocol and a payload of the second command, and
wherein the validity score is determined based on the determination of zero or more differences.

14. A non-transitory computer-readable medium storing program code, the program code executable by a system to cause the system to:
(a) determine a first command conforming to an industrial control protocol and transmitted to a first computing device of a first computing network;
(b) determine whether a second command corresponding to the first command was detected by a second computing device of a second computing network;
(c) determine whether the first command was transmitted from one of one or more predetermined Internet Protocol subnets;
(d) determine whether the command was issued by an expected issuing device;
(e) determine whether the command was issued by an expected issuing software application; and
determine a validity score based on determinations (b) through (e) and associating the validity score with the command.

15. A medium according to claim 14, the program code executable by a system to cause the system to:
determine a response action based on the validity score; and
control execution of the response action.

16. A medium according to claim 14, the program code executable by a system to cause the system to:
receive a network traffic log from the second computing device,
wherein determination of whether a second command corresponding to the first command was detected by the second computing device is based on the network traffic log.

17. A medium according to claim 16, the program code executable by a system to cause the system to:
receive an application log from a third computing device,
wherein determination of whether the command was issued by an expected issuing software application is based on the application log.

18. A medium according to claim 17, the program code executable by a system to cause the system to:
determine whether a user associated with the command was authorized to use the expected issuing device at a time the command was issued,
wherein the validity score is determined based on whether the user associated with the command was authorized to use the expected issuing device at a time the command was issued.

19. A medium according to claim 14, wherein determination of whether a second command corresponding to the first command was detected by the second computing device comprises determination of zero or more differences between a type, a protocol and a payload of the first command and a type, a protocol and a payload of the second command, and
wherein the validity score is determined based on the determination of zero or more differences.
